(19) United States
(12) Patent Application Publication
(10) Pub. No.: US 2010/0276341 A1
(43) Pub. Date: Nov. 4, 2010

(54) Heat and Water Recovery From Tailings Using Gas Humidification/Dehumidification

(76) Inventors: Brian C. Speirs, Calgary (CA); James Andrew Dunn, Calgary (CA)

Correspondence Address: EXXONMOBIL UPSTREAM RESEARCH COMPANY, P.O. Box 2189, (CORP-URC-SW 359), Houston, TX, 77252-2189, US

(21) Appl. No.: 12/678,087

(22) PCT Filed: Oct. 9, 2008
(86) PCT No.: PCT/US08/79406

§ 371 Date: Jun. 29, 2010

(30) Foreign Application Priority Data
Nov. 2, 2007 (CA) 2,609,419

(51) Int. Cl. C10G 71/00; F28B 3/00; F28C 1/00; B01D 5/00; C02F 1/12; C02F 1/16

(52) U.S. Cl. 208/391; 261/128; 261/147; 261/4; 261/149; 261/136

(57) ABSTRACT

A system and method of recovering heat and water from a slurry, such as tailings from oil sands extraction, is provided. The method includes providing the tailings to a humidification vessel, adding a sufficiently dry gas directly to the slurry in the vessel to form warm, water-saturated gas, such that heat and water are recovered from the slurry, removing the warm, water-saturated gas from the humidification vessel, providing the warm, water-saturated gas to a direct contact condensation vessel, cooling the gas in the condensation vessel to condense the water from the gas, thereby extracting water from the warm, water-saturated gas and recycling the dry gas, and recovering the water from the condensation vessel. Water which is of high quality, suitable for steam generation is obtained by a method in accordance with the present invention.

### CROSS-REFERENCE TO RELATED APPLICATIONS

This application claims priority from Canadian Patent Application number 2,609,419 which was filed on 2 Nov. 2007, which is incorporated herein by reference.

### FIELD OF THE INVENTION

The present invention relates generally to oil (tar) sands mining. More particularly, the present invention relates to a system and method of recovering heat and water from oil sands tailings using a gas humidification/dehumidification process. The water recovered from this process can be used for steam generation in thermal oil recovery operations, extraction, utility purposes or other processes recognized by those skilled in the art requiring the use of water, steam or a combination thereof.

### BACKGROUND OF THE INVENTION

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of prior art.

Oil sands are sand deposits which, in addition to sand, comprise clays, connate-water and bitumen. Depending on geographic location, bitumen may be recovered by mining or in-situ thermal methods. Examples of thermal in-situ recovery processes include but are not limited to steam-assisted gravity drainage (SAGD), cyclic steam stimulation (CSS), and various derivatives thereof, such as solvent-assisted SAGD (SA-SAGD), steam and gas push (SAGP), combined vapor and steam extraction (SAVEX), expanding solvent SAGD (ES-SAGD), constant steam drainage (CSD), and liquid addition to steam for enhancing recovery (LASER), as well as water flooding and steam flooding processes. An example of SAGD is disclosed in U.S. Pat. No. 4,344,485 (Butler). An example of SA-SAGD is disclosed in U.S. Pat. No. 5,899,274. An example of ES-SAGD is disclosed in U.S. Pat. No. 6,230,814 (Nasretal). An example of SAVEX is disclosed in U.S. Pat. No. 6,662,872 (Gutek). An example of CSS is disclosed in U.S. Pat. No. 4,280,559 (Best). An example of LASER is disclosed in U.S. Pat. No. 6,708,759 (Leaute et al.). Recovering the highly viscous bitumen from the oil sand poses numerous challenges, particularly since large quantities of heat and water are required to extract the bitumen. Further, most oil sand deposits are located in remote areas (such as, for example, the Fort McMurray area of northern Alberta, Canada), which can contribute to increased costs for transportation and processing, especially in harsh weather conditions.

Oil sand ore in a mining and extraction operation is typically processed using mechanical and chemical techniques to separate the bitumen from the sands. One of the most common extraction techniques is bitumen froth flotation. Hot water, air and process aides are added to the sands, resulting in the formation of an oil-rich froth that “floats” or rises to form a distinct hydrocarbon phase that can be separated from the aqueous layer. The waste ore (sand, clay, rock, other wastes) in combination with the spent processing water and reagents from the plant are known as tailings.

The properties of tailings are dependent on the ore body being mined, the grinding and processing circuits, the reagent properties and the thickening process prior to disposal. Tailings can be disposed of or stored in a variety of different methods; however, the overall oil sands extraction process creates a large volume of waste requiring disposal.

An additional improvement to the overall oil sands extraction process is to enhance the total energy efficiency. Disposal of tailings into an open pool or pit results in the release of residual heat into the atmosphere, wasting energy. A reduction in this heat loss would increase the efficiency of the process, and reduce energy costs. Thus, there has been a need to reduce input energy by recovering the energy output at the end of the oil extraction process.

Attempts to recover heat, water and other reagents used in the oil sands extraction process have been described in the prior art. However, there has been limited success in achieving effective energy and resource conservation methods, despite the recent progress made in oil sands bitumen extraction technology and the increasing global awareness of industrial environmental impacts.

U.S. Pat. Nos. 4,343,691; 4,561,965; and 4,240,897, all to Minkkinen, are directed to heat and water vapor recovery from tailings for use in the extraction process. These patents highlight the extraction processes employed at the time of the invention. Hydrotransport was not an established technology, and the schemes presented in the aforementioned patents did not anticipate such a process. In addition, process temperatures were much higher than currently used; the concept of a closed loop gas process, or use of other gases for the purposes of corrosion control were not considered. The air used is given a range of 2000-5000 scf/ton, or about 7-17% on a mass basis. In addition, the prior art does not identify facilities that are aimed at recovering the condensed water as a separate stream.

WO 2004/060812 to Klausner describes using waste heat from an industrial source for desalinating sea water for potable use. Cold water provided from deep ocean water is used to condense water from the air, and the low grade heat is discharged to the environment with the seawater.

In the patents described in the prior art, the amount of water recovered from tailings or other methods is typically in the range of 0-5%. This low water recovery is insignificant in comparison to the overall water usage requirements for an oil sands mining operation for bitumen extraction and thus has made very little impact on the commercial process.

There exists a need to more efficiently and successfully recover residual heat and water for either bitumen extraction or more suitably for in-situ thermal oil recovery processes that does not rely on the economy of scale concept for development. A more energy efficient thermal oil and/or mining recovery method would reduce costs and improve environmental performance. It is, therefore, desirable to provide a cost effective means of recovering residual heat and clean, high quality water suitable for thermal oil recovery processes from tailings streams, thereby reducing the overall amount of required energy during the oil sands extraction process, and providing a clean, high quality water source for other industrial bitumen oil recovery purposes.

### SUMMARY OF THE INVENTION

It is an object of the present invention to improve over previous systems and methods of heat and water recovery from the processing of oil sands. Further, it is an object of the present invention to apply these methods to other industrial processes that generate tailings, slurries, or similar products.

In a first aspect, the present invention provides a method of recovering heat and water from a slurry derived from an oil sands mining operation, comprising the steps of: a) providing the slurry to a first vessel; b) adding a gas directly to the slurry in the vessel to form warm, water-saturated gas, such that heat and high quality water are recovered from the slurry; c) removing the warm, water-saturated gas from the first vessel; d) providing the warm, water-saturated gas to a second vessel; e) cooling the gas in the second vessel to condense water from the warm, water-saturated gas, thereby recovering heat and water from the saturated gas and subsequently forming a lower temperature, lower humidity gas for re-use in step b); and f) recovering the high quality water from the second vessel.

As used in the present application, a ‘vessel’ is intended to describe any device suitable for the purpose of humidifying gas and condensing the water vapor. The method of the present invention may be carried out in a single vessel (such as a cooling tower or derivative thereof) or in one or more multiple vessels. Optionally, a similar method could be used where ambient air is used as a partial or complete make-up stream.

In another aspect of the present invention there is provided a system for recovering heat and water from an oil sands slurry, comprising: a direct contact humidification vessel for recovering heat and water from a slurry derived from the oil sands slurry which has been separated from a bitumen froth or a bitumen-solvent mixture; a gas source for supplying a gas to the direct contact humidification vessel; a direct contact condenser for condensing water from the gas which has been humidified in the direct contact humidification vessel; a vessel for recovering water which has been condensed from the humidified gas in the condenser; and a water source for supplying water to the condenser, wherein the water is heated with heat from the humidified gas and recovered. The system can further comprise a separation vessel for separating bitumen froth from the oil sands slurry or separating the bitumen-solvent mixture from water, solids or precipitated asphaltenes, prior to entering the direct contact humidification vessel.

The slurry is typically tailings obtained from an oil sands bitumen extraction process. Such extraction processes typically result in the production of bitumen froth and middlings in a first separation vessel as well as tailings. The tailings are typically a mixture of sand, water, clays and other residual components, and are formed in various stages of the bitumen extraction process.

A direct contact humidification vessel can be used to humidify the gas that is added to tailings. A direct contact condenser, such as that described in the prior art by Bharathan in U.S. Pat. No. 5,925,291, can be used to condense and recover the water from the warm, wet gas. Cold water from a river, pond or the like, can be added to the direct contact condenser to cool and condense the water vapor from the warm, wet gas in the direct contact condenser.

In order to prevent contamination of the condensed water, a heat exchanger may be used to segregate the clean condensed water from the cooling source (river or pond water).

Typically, air, nitrogen or any other suitable gas can be used. In one embodiment of the present invention, methane gas is used in a once-through fashion using the pipeline delivery pressure in order to reduce the power required to circulate gas in a closed or ambient pressure supply scheme.

Water recovered from the segregated method and system is of high quality and is effectively of distilled or deionized water quality, suitable for use as boiler feedwater to generate steam for use in the mining operation or nearby thermal in-situ oil recovery operations, such as steam-assisted gravity drainage (SAGD), cyclic steam stimulation (CSS), solvent-assisted SAGD (SA-SAGD), steam and gas push (SAGP), combined vapor and steam extraction (SAVEX), expanding solvent SAGD (ES-SAGD), constant steam drainage (CSD), liquid addition to steam for enhancing recovery (LASER), water flooding and steam flooding processes, or any derivative known or contemplated in the art. The water condensed can be segregated from the cooling source, is of high purity, and represents additional value than a co-mingled stream. Examples of such operations are disclosed in U.S. Pat. Nos. 4,116,275; 4,280,559; 4,344,485; 5,899,274; 6,230,814; 6,662,872; and 6,708,759 the disclosures of which are each incorporated herein by reference in their entirety.

Advantageously, the method and system of the present invention can be used to reduce the amount of energy required for processing raw oil sands by recovering heat from the tailings. This reduced energy requirement can result in lowered costs and improved environmental performance.

Another advantage of at least one aspect of the present invention is that no heat exchange surface is required. Such surfaces are known to foul, and are subject to corrosion and erosion damage. The heat and water can be recovered using direct humidification and condensation. This results in a more efficient and cost effective recovery means.

The source gas which is humidified and dehumidified can be reused in accordance with the method and system of the present invention, or used in a single pass and subsequently sent to other process units if desired. The source gas can be readily obtained from sources known in the art. The recycling of gas can reduce costs associated with oil sands operations.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates one scheme of the heat and water recovery from tailings, in accordance with one aspect of the present invention.

FIG. 2 illustrates a different embodiment of the scheme from FIG. 1, without the coolant heat exchanger.

FIG. 3 illustrates a different embodiment of the scheme from FIG. 1, using methane as an exemplary once through gas.

Many aspects of the present invention can be better understood with reference to the above drawings. The elements and features shown in the drawings are not necessarily to scale, emphasis instead being placed upon clearly illustrating principles of exemplary embodiments of the present invention. Moreover, certain dimensions may be exaggerated to help visually convey such principles. In the drawings, reference numerals designate like or corresponding, but not necessarily identical, elements throughout the several views.

### DETAILED DESCRIPTION

In the following detailed description section, the specific embodiments of the present invention are described in connection with preferred embodiments. However, to the extent that the following description is specific to a particular embodiment or a particular use of the present invention, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

Generally, the present invention provides a method of recovering heat and water from a slurry derived from an oil sands mining operation, comprising the steps of: a) providing a slurry to a first vessel; b) adding a gas directly to the slurry in the vessel to form warm, water-saturated gas, such that heat and high quality water are recovered from the slurry; c) removing the warm, water-saturated gas from the first vessel; d) providing the warm, water-saturated gas to a second vessel; e) cooling the warm, water-saturated gas in the second vessel to condense water therefrom, thereby recovering the heat and high quality water and subsequently forming a substantially dry gas for re-use in step b); and f) recovering the high quality water from the second vessel.

The present invention also provides a system for recovering heat and water from an oil sands slurry, comprising: a direct contact humidification vessel for recovering heat and water from a slurry derived from the oil sands slurry which has been separated from a bitumen froth or a bitumen-solvent mixture; a gas source for supplying a gas to the direct contact humidification vessel; a condenser for condensing water from the gas which has been humidified in the direct contact humidification vessel; a vessel for recovering water which has been condensed from the humidified gas in the condenser; and a water source for supplying water to the condenser, wherein the water is heated with heat from the humidified gas and recovered. The system can further comprise a separation vessel for separating bitumen froth from the oil sands slurry or separating the bitumen-solvent mixture from water, solids or precipitated asphaltenes, prior to entering the direct contact humidification vessel. Generally, the recovered water is of high quality suitable for the generation of steam.

As used herein, a “slurry” refers to any liquid or donor fluid that can comprise solids from which heat and/or water can be recovered or solid-liquid mixture from which heat and/or water can be recovered, such as tailings obtained from a oil sands extraction process, for example.

As used herein, “water” refers to water which is purified or unpurified, filtered or unfiltered, or refers to any moisture (such as wet gas, for example) from which this purified/unpurified or filtered/unfiltered water can be obtained.

As used herein, “high quality” water refers to water which can be potable, or re-used in other processes within the mining operations or as boiler feed water for in-situ thermal oil or hydrocarbon recovery operations, without offering any significant contamination to the material being processed. The in-situ oil or hydrocarbon recovery operations can include steam-assisted gravity drainage (SAGD), cyclic steam stimulation (CSS), and various derivatives thereof, such as solvent-assisted SAGD (SA-SAGD), steam and gas push (SAGP), combined vapor and steam extraction (SAVEX), expanding solvent SAGD (ES-SAGD), constant steam drainage (CSD), and liquid addition to steam for enhancing recovery (LASER), as well as water flooding and steam flooding processes known or contemplated in the art. High quality water may also be effectively of distilled and/or deionized water quality.

As used herein, “surface water” refers to water obtained from a surface source, such as a river, pond or a source which produces process-affected water. “Process-affected” water may be defined as any water which has been previously used in an industrial process. Further, and as used herein, “subterranean” water refers to any water sourced from a well.

Typically, tailings from any source can be used. In accordance with exemplary embodiments of the present invention, tailings removed from oil sands processing methods known in the art can be used. The raw oil sands are conditioned by adding warm water and transporting the slurry in a pipeline, such as in a hydrotransport process (or any suitable transport method known in the art). The conditioned oil sands are then sent to a separation vessel (or any appropriate vessel known in the art) to recover bitumen froth, from which bitumen products are obtained. The tailings usually comprise water, sand, clays, residual hydrocarbons, and contain a significant amount of heat. In most oil sands operations, tailings are discarded to open pits commonly referred to as “tailings ponds”. While water is stored in the tailings pond for potential future use, residual heat is released to the atmosphere and some water is subsequently lost to evaporation.

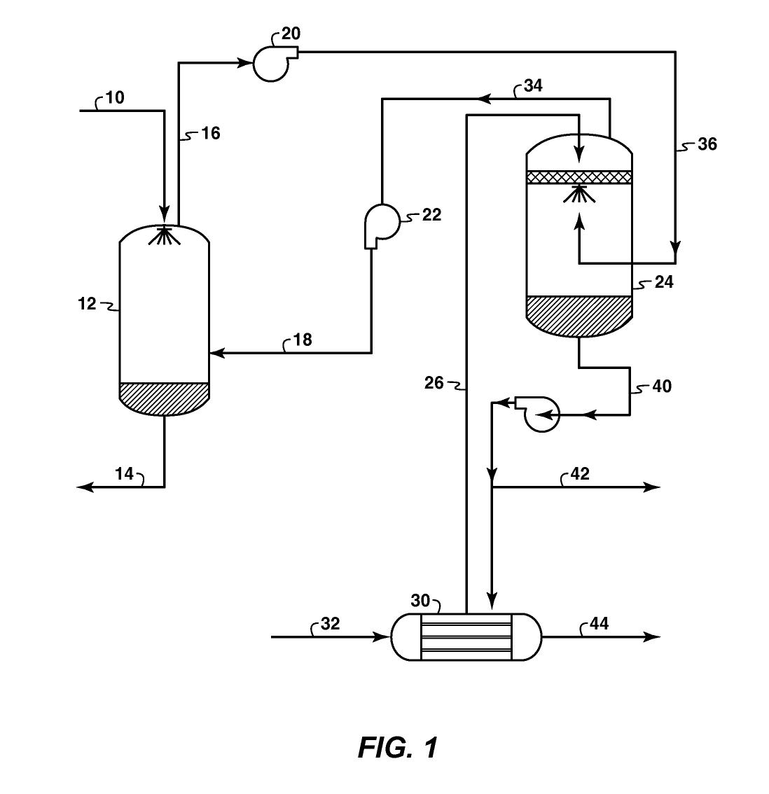

One embodiment of a heat and water recovery method and system in accordance with the present invention is illustrated in FIG. 1. The scheme illustrated in FIG. 1 can typically be used to provide clean, distilled water for use in-situ thermal oil recovery operations such as a SAGD operation, or could be used in the oil sands extraction process, or any other suitable process known to the skilled worker. Warm tailings from the separation vessel enter tailings conduit 10 and thereafter enter a slurry containment vessel, such as a direct contact humidification vessel 12, for processing to remove heat and water. Typically, warm tailings from the raw sands are in the range of about 15° to about 90° C., and more typically about 35° to about 45° C. The temperature of the tailings can vary depending on the source of the oil sand (such as would be expected for seasonal variations), the amount of heat added to the raw oil sands to extract the bitumen froth, and type of tailings (primary or secondary extraction, or from solvent recovery units). The heat source for the humidification process is typically derived from warm tailings.

Tailings can be filtered or graded to partially remove or remove all solids to various criteria (particle size, density, etc.) prior to entry into the direct contact humidification vessel (12), using any suitable filtering or separation system known in the art.

In accordance with the exemplary embodiment shown in FIG. 1, warm tailings enter the top of the direct contact humidification vessel 12 through a tailings conduit 10, are distributed by nozzles or similar devices and, by gravity, the tailings typically migrate to the bottom of the vessel. Cooled tailings (generally in the range of about 5° C. to about 40° C. and more typically between 10° C. and 20° C.) exit through a cool tailings conduit 14 near the bottom of the vessel. The temperature of the cooled tailings is constrained on the low side by freezing, and on the high side by the inlet temperature to the direct contact humidification vessel. The process can be operated between these two extremes by a combination of design and operating condition choices, such as the desire to maximize heat recovery, or water production, or minimize pumping costs, etc. These cooled, concentrated tailings are typically sent to a tailings pond in accordance with common tailings disposal methods known in the art.

The direct contact humidification vessel 12 can have one or more conduits for receiving gas. Depending on the specific requirements of individual application, the gas to tailings (slurry) mass ratio may be about 2:1 to about 0.25:1, optionally from about 1.5:1 to about 0.5 to 1, or further optionally about 1:1. In the example shown in FIG. 1, intake conduit 18 supplies cooled gas to the vessel 12. A blower 22 forces gas through the intake conduit 18 and into the vessel 12. The gas contacts the tailings in the vessel 12 that have entered via the tailings conduit 10. The gas is thus warmed from the tailings and fully saturated with water vapor. The warm, saturated gas exits the vessel 12 via an outgoing warm gas conduit 16. Optionally, the gas can be blown through the warm gas conduit 16 with a warm gas blower 20. The direct contact vessel may have many different types of internal features, ranging from no internal devices, to inclusion of packing or similar devices intended to provide a method to increase surface area and mass transfer.

Any suitable gas can be used to recover water and heat from the slurry. While air is typically used, nitrogen gas (N₂) may be advantageously used, as this gas minimizes corrosion in the various conduits. Nitrogen is typically available, or can be recovered from an air stream through any gas separation technique known in the art. Methane is also recognized as a gas that may prove advantageous for a once-through gas humidification-dehumidification operation. However, it would be well understood to the person of ordinary skill in the art that many other gases can be used such as, for example, carbon dioxide (CO₂). Air or any other suitable gas could be used in a once through fashion if desired.

Warm, water-saturated gas from the warm gas conduit 16 enters a suitable condenser, such as a direct contact condenser 24. In the example of the embodiment shown in FIG. 1, warm water-saturated gas from the warm gas conduit 16 and through a warm gas intake conduit 36 enters the condenser 24. A cold water conduit 26 supplies cold water to the direct contact condenser 24.

As the water vapor contained in the warm, saturated gas condenses in the direct contact condenser 24, water settles to the bottom of the condenser 24. In turn, the once warm saturated gas is now cooler and dryer and leaves the condenser 24 via a gas conduit 34. The cool gas is returned to the intake conduit 18 via the blower 22 as referred to above, and back in to the direct contact humidification vessel 12 to recover heat and water from warm tailings. The water which has been removed from the warm, saturated gas leaves the direct contact condenser 24 via a water conduit 40. The temperature of the water which leaves the direct contact condenser 24 is set by the temperature of the warm saturated gas, cooling water temperature, and their respective flow rates, but would typically be in the range from about 2° C. to 50° C., more typically about 20° C. to 40° C. Any water which leaves the direct contact condenser is high quality water at this point. The water can then be stored in an appropriate water vessel prior to proceeding to one or more locations in the oil sands extraction process, or used as a source of boiler feedwater for thermal oil recovery operations (SAGD) or the like. In one possible embodiment, the high quality water can be used for further processing, potation, steam generation or any suitable use, through clean water conduit 42. Part of the high quality water can enter the cooler 30 to be cooled before being sent through cold water conduit 26 to provide high quality water cooling for the direct contact condenser.

The high quality water cooler 30 can be a heat exchanger or the like. The cooler 30 segregates the high quality water from the lower quality water made available through cooling source 32. The initial temperature of cooling water is usually in the range of 2° C. to 20° C. In the event that seasonal temperature variations may cause the cooling water source to be above 20° C., the efficiency of the process is diminished. However, cooling water provided through a long pipeline may exhibit only minor temperature variations due to heat transfer with the earth, thus minimizing any seasonal temperature variations of the water supply. The lower quality water (surface, subterranean or process affected water) is heated in the cooler 30, then progresses to another step in the process through warm water conduit 44. The heat thus absorbed reduces the energy requirements otherwise required.

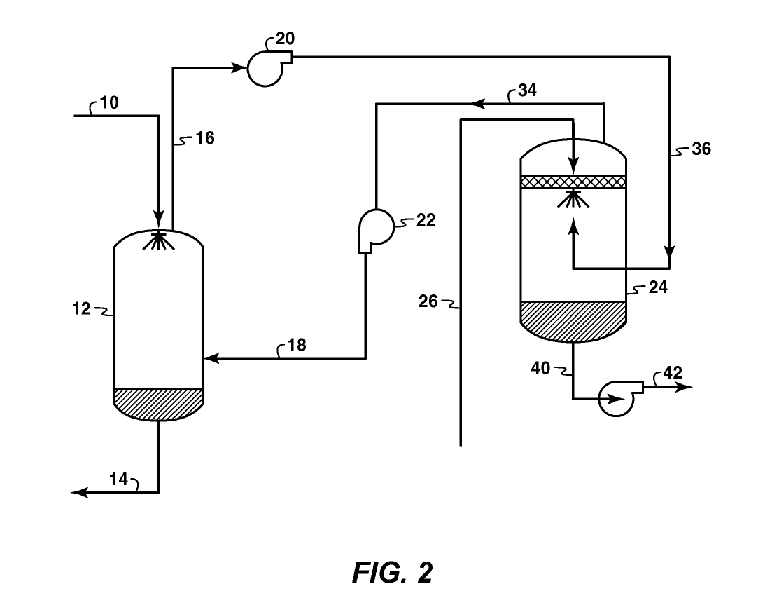

FIG. 2 illustrates another embodiment of the method and system of the present invention. Cold, lower quality water (from surface, subterranean or process affected water source) enters the direct contact condenser 24 directly via the cold water conduit 26. This scheme reduces the cost and complexity of FIG. 1, but does not allow the segregation of the recovered high quality water from the lower quality cooling source 26. It would be more typically used in traditional oil sands mining operations where there was no need for an additional clean water supply.

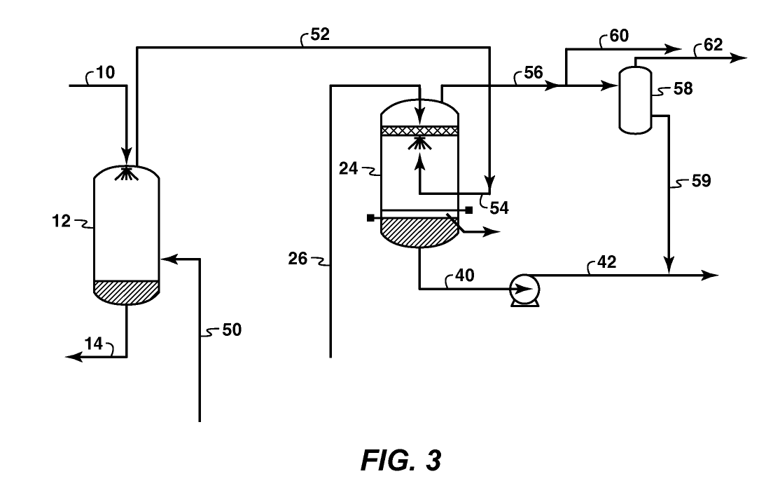

FIG. 3 shows another embodiment of the system and method of the present invention using CH₄ (methane) gas available at the required pressure from a pipeline. A condition of meeting pipeline specifications is a very low absolute humidity level, which is advantageous for maximizing heat and water recovery. Methane, which enters the direct contact humidification vessel 12 through gas conduit 50 and which has been saturated by the warm tailings entering the vessel as described above, leaves as wet methane through a wet methane conduit 52 to a wet methane intake conduit 54 and into the direct contact condenser 24. Dehumidification of the wet methane proceeds in the direct contact condenser 24 as described herein, in conjunction with a cool water source 26. As described in the previous examples, water recovered from the dehumidification process is of high quality and may be segregated from coolant water (i.e. cool river or pond water). This high quality water is cooled via the low quality river or pond water or the like via an exchanger. Alternatively, the high quality may be commingled with the low quality water in the dehumidification vessel. Cooled methane then leaves the direct contact condenser 24 via a cool methane conduit 56. The cooled methane can then be further dehydrated or can be sent directly to a burner (via a conduit, 60) for use. Dehydration of methane can be performed using a glycol dehydration vessel 58 as illustrated, supplying dry methane meeting the required specifications to further processes via dry gas conduit 62. However, any other dehydration process known in the art may be used, such as membrane, refrigeration or desiccant systems, for example. Additional water can then be recovered (stream 59) from the glycol dehydration vessel 58 for further oil sands processing uses, as boiler feed water supply to a thermal oil recovery operation (SAGD or similar), or other uses as appropriate.

Methane has been shown to be particularly advantageous for the recovery method in accordance with one embodiment of the present invention. The use of methane from a high pressure source removes requirement for fans, thus reducing the need for extra power supply. The dry methane provides an additional function of removing oxygen from the tailings. This greatly reduces the occurrence of corrosion on the remainder of the tailings disposal system. In addition, the use of methane allows for the gas to be used in a once through set up. This once through set up results in increased water recovery from the process as well as a higher overall heat capture from the tailings.

Solvents which may be added to the tailings for additional extraction of bitumen can be removed from the direct contact condenser 24 or via other methods known to those skilled in the art (i.e. membranes, etc.), prior to removal of the high quality water. The vessel can take the form of a common 3-phase separator, wherein light hydrocarbons float on top of the water, and are removed through a separate conduit 64.

The humidification/dehumidification process in accordance with different aspects of the present invention can save energy and costs in the oil sands bitumen extraction process. This approach can be extremely beneficial to improve the environment performance of the oil sands operation and in reducing operating costs associated with bitumen extraction.

The above-described embodiments of the present invention are intended to be examples only. Alterations, modifications and variations may be effected to the particular embodiments by those of skill in the art without departing from the scope of the invention, which is defined solely by the claims appended hereto.

1. A method of recovering heat and high quality water from a slurry derived from an oil sands mining operation, comprising the steps of:
a) providing the slurry to a first vessel;
b) adding a gas directly to the slurry in the vessel to form warm, water-saturated gas, such that heat and high quality water are recovered from the slurry;
c) removing the warm, water-saturated gas from the first vessel;
d) providing the warm, water-saturated gas to a second vessel;
e) cooling the warm, water-saturated gas in the second vessel to condense water therefrom, thereby recovering the heat and the high quality water from the saturated gas and subsequently forming a substantially dry gas for re-use in step b); and
f) recovering the high quality water from the second vessel.

2. The method of claim 1, wherein the slurry is tailings obtained from oil sands bitumen extraction.

3. The method of claim 1, wherein the first vessel is a direct contact humidification vessel.

4. The method of claim 1, wherein the second vessel is a direct contact condenser.

5. The method of claim 1 wherein the gas is air, nitrogen, methane or any suitable gas.

6. The method of claim 5 wherein the recovered high quality water is used for generating steam.

7. The method of claim 6, wherein the steam is for in-situ oil or hydrocarbon recovery.

8. The method of claim 7, wherein the in-situ oil or hydrocarbon recovery is steam-assisted gravity drainage (SAGD), cyclic steam stimulation (CSS), solvent-assisted SAGD (SA-SAGD), steam and gas push (SAGP), combined vapor and steam extraction (SAVEX), expanding solvent SAGD (ES-SAGD), constant steam drainage (CSD), liquid addition to steam for enhancing recovery (LASER), water flooding, a steam flooding process, or a derivative thereof.

9. The method of claim 1 wherein the recovered high quality water is for use in oil sands bitumen extraction.

10. The method of claim 1, wherein the recovered high quality water is of distilled or deionized water quality.

11. The method of claim 1, wherein the recovered water is about 2° C. to about 85° C.

12. The method of claim 1, wherein the recovered water is about 20° C. to about 40° C.

13. The method claim 1 wherein in step b), the first vessel has a gas:slurry mass ratio of from about 2:1 to about 0.25:1.

14. The method claim 1, wherein in step b), the first vessel has a gas:slurry mass ratio of from about 1.5:1 to about 0.5:1.

15. The method of claim 1, wherein in step e), the cooling step is provided by cold water added to the second vessel.

16. (canceled)

17. The method of claim 1, wherein a portion of the high quality recovered water is passed through a cooler prior to recycling the high quality recovered water back to the second vessel.

18. The method of claim 17, wherein the high quality water recovered from the second vessel is sent through the cooler, thereby warming the cold water.

19. The method of claim 1, which is carried out in more or more additional vessels.

20. A system for recovering heat and water from an oil sands slurry, comprising:
a direct contact humidification vessel for recovering heat and water from a slurry derived from the oil sands slurry which has been separated from a bitumen froth or a bitumen-solvent mixture;
a gas source for supplying a gas to the direct contact humidification vessel;
a direct contact condenser for condensing water from the gas which has been humidified in the direct contact humidification vessel;
a vessel for recovering water which has been condensed from the humidified gas in the condenser; and
a water source for supplying water to the condenser, wherein the water is heated with heat from the humidified gas and recovered.

21. The system of claim 20, wherein the recovered water is for industrial use.

22. The system of claim 20, further comprising a separation vessel for separating the bitumen froth from the oil sands slurry or separating the bitumen-solvent mixture from water, solids or precipitated asphaltenes, prior to entering the direct contact humidification vessel.

23. The system of claim 20, wherein the gas is air, nitrogen, methane or any suitable gas.

24. The system of claim 20 wherein the recovered water is of high quality suitable for the generation of steam.

25. The system of claim 24, wherein the steam is for in-situ oil or hydrocarbon recovery.

26. The system of claim 25, wherein the in-situ oil or hydrocarbon recovery is steam-assisted gravity drainage (SAGD), cyclic steam stimulation (CSS), solvent-assisted SAGD (SA-SAGD), steam and gas push (SAGP), combined vapor and steam extraction (SAVEX), expanding solvent SAGD (ES-SAGD), constant steam drainage (CSD), liquid addition to steam for enhancing recovery (LASER), water flooding, a steam flooding processes, or a derivative thereof.

27. (canceled)

28. (canceled)

29. The system of claim 20, further comprising a cooler for cooling the recovered water prior to recycling the recovered water to the direct contact condenser.

30. The system of claim 29, wherein the water recovered from the water vessel is sent through the cooler, thereby cooling the recovered water and heating the colder water.

31. The system of claim 20, further comprising one or more additional vessels.

32. The system of claim 23, wherein the methane is dehydrated in a further dehydration vessel after removal of methane from the second vessel subsequent to removal of the water therefrom.

33. (canceled)

34. (canceled)
